(19) United States
(12) Patent Application Publication
(10) Pub. No.: US 2020/0114442 A1
(43) Pub. Date: Apr. 16, 2020

(54) METHOD AND APPARATUS FOR MONITORING A BAR BLADE CHUCKING AND/OR A BLADE SLOT OF A BAR BLADE CUTTER HEAD FOR BEVEL GEAR PRODUCTION

(71) Applicant: Klingelnberg AG, Zurich (CH)

(72) Inventor: Matthias Daniels, Bergisch Gladbach (DE)

(21) Appl. No.: 16/597,073

(22) Filed: Oct. 9, 2019

(30) Foreign Application Priority Data
Oct. 11, 2018 (DE) 102018125135.1

(51) Int. Cl. B23F 23/12; B23F 9/10

(52) U.S. Cl. CPC B23F 23/1218; B23F 9/10

(57) ABSTRACT

Method for monitoring a bar blade chucking and/or a blade slot of a bar blade cutter head for bevel gear production, having the following method steps:
providing a main body (26) of a bar blade cutter head (4),
wherein the main body (26) comprises blade slots (30) for accommodating bar blades (10), and
wherein a component (10), such as a bar blade (10), a test specimen, or the like, is chucked in a detachable and replaceable manner in at least one blade slot (30) of the main body (26) of the bar blade cutter head (4);
exciting oscillations of the component (10);
measuring the displacement and/or velocity and/or acceleration of the component (10);
analyzing the measurement.

### CROSS-REFERENCE TO RELATED APPLICATIONS

This application claims priority under 35 U.S.C. §§ 119(a)-(d) to German patent application no. DE102018125135.1 filed Oct. 11, 2018, which is hereby expressly incorporated by reference as part of the present disclosure.

### FIELD OF THE INVENTION

The present disclosure relates to a method and an apparatus for monitoring a bar blade chucking and/or a blade slot of a bar blade cutter head for bevel gear production.

### BACKGROUND

Bar blade cutter heads are used for producing bevel gears. A bar blade cutter head typically consists of a main body having bar blades, wherein the main body comprises blade slots having clamping devices for chucking the bar blades. The bar blades are used for the chip-removing soft machining with defined cutting edge and are frequently provided as coated hard metal bars.

The bar blades are mounted in a detachable manner on the main body of the cutter head and are typically each clamped with the aid of a movable clamping element of the clamping device in a blade slot against contact surfaces of the blade slot. The clamping element is displaced using one or more screws to constrict the blade slot to chuck the bar blade. It can be provided that one or more screws clamp a bar blade in direct contact with the bar blade shaft in the blade slot. It can be provided that so-called parallel plates are arranged between the bar blade and a wall delimiting the blade slot to set the radial position of a respective bar blade. The reliable seat of a respective bar blade in the main body is decisive for a stable manufacturing process and achieving the required workpiece quality.

The bar blade seat of a bar blade in a blade slot and/or the quality of the chucking of a bar blade in the blade slot can be impaired by a plurality of influencing factors, wherein only a few are listed as examples hereafter:
The bar blade cutter head has collided as a result of incorrect operation of a machine tool with a further component of the machine tool or a workpiece accommodated therein and has thus been deformed including the blade slots.
The manufacturing tolerances of a pairing of bar blade and blade slot do not permit reliable chucking of the bar blade.
The protruding length of the bar blade is not correctly set.
The contact surfaces of a blade slot and/or a bar blade are outside the provided tolerance because of wear.
A thread of a clamping screw of a clamping device is soiled or manufactured outside the predetermined tolerance.
The torque has not been correctly set during the clamping of a respective bar blade.
The coating of a bar blade is uneven, so that partial jamming of the coating in the blade slot occurs.

A deficient and/or impairing chucking of a bar blade in a blade slot of the main body can result in a fracture of the bar blade, vibration of the bar blade, chip welds on the rake face of the bar blade, and similar disadvantageous effects during the manufacturing process.

A fracture of the bar blade generally makes it unusable for further use. The vibration of the bar blade can result in waviness, inadequate topography of the tooth flanks, and possibly visible chatter marks on the finished tooth flanks, so that the workpiece is possibly not suitable for the hard-fine machining. Chip welds in the region of the rake face of a bar blade can result in clogging (chip clogging) of an intermediate space provided between adjacent bar blades, wherein the accumulation of the chips impairs the machining quality and can in turn result in a fracture or damage of the affected bar blade.

Each of these cases share the feature that the bar blade cutter head has to be removed from the machine tool and partially or completely reequipped. In addition to the costs for repairing the bar blade cutter head, this can additionally result in costly shutdown times in the manufacturing if a replacement tool is not readily available.

In summary, it is to be stated that there is a plurality of influencing factors which can impair a bar blade chucking on a main body of a cutter head, wherein the consequences of inadequate chucking of one or more bar blades can result in high costs.

### SUMMARY

Against this background, the present disclosure addresses the technical problem of specifying a method and an apparatus for monitoring a bar blade chucking of a bar blade cutter head.

According to a first aspect, the disclosure relates to a method for monitoring a bar blade chucking and/or a blade slot of a bar blade cutter head for bevel gear production, having the following method steps: providing a main body of a bar blade cutter head, wherein the main body comprises blade slots for accommodating bar blades, and wherein a component, such as a bar blade, a test specimen, or the like, is chucked in a detachable and replaceable manner in at least one blade slot of the main body; exciting oscillations of the component; measuring the displacement and/or velocity and/or acceleration of the component; analyzing the measurement.

The method therefore enables the evaluation of the chucking of a component, such as a bar blade, a test specimen, or the like, in the finished state installed on the main body of the bar blade cutter head, so that independently of which of the influencing variables mentioned at the outset impairs the seat of the component, a deficient chucking of the component in the blade slot can be detected.

If one or more bar blades are fastened on the main body of the bar blade cutter head, the bar blade cutter head can be configured for chip-removing workpiece machining for producing a bevel gear. The method enables in this case the checking of the seat of a respective bar blade in the associated blade slot. The tool system provided for the bevel gear manufacturing can therefore be checked.

If one or more test specimens are fastened on the main body of the bar blade cutter head, the manufacturing quality and/or the wear state of the blade slots of the main body of the bar blade cutter head can be checked. The main body of the cutter head can thus be checked in particular with the aid of a standardized test specimen, which can also have a standardized contact with a contact element of the measuring system.

If the analysis has the result, for example, for a bar blade chucked on the main body that a measured deflection and/or velocity and/or acceleration of the bar blade as a result of the oscillation excitation exceeds a predetermined maximum permissible deflection and/or velocity and/or acceleration, the seat of the affected bar blade is checked. The bar blade can possibly be re-chucked, the faces of the bar blade and the blade slot abutting one another in the clamped state can be cleaned, the bar blade and the blade slot can be measured, or other measures can be taken to recognize and remedy the cause of the deficient chucking. It is decisive that the inadequate chucking of the affected bar blade can be recognized before the cutter head is released for the manufacturing and possibly causes the problems described at the outset.

The above-described method can similarly be carried out on a bar blade cutter head which has not achieved the required machining quality in the manufacturing, to establish the causes thereof and to collect data for structurally-equivalent bar blade cutter heads or structurally-equivalent cutter head main bodies.

The above-described method can similarly be carried out on a bar blade cutter head which has achieved the required machining quality in the manufacturing, to collect reference data for structurally-equivalent bar blade cutter heads or structurally-equivalent cutter head main bodies.

If the analysis shows, for example, for a test specimen chucked on the main body that a measured deflection and/or velocity and/or acceleration of the test specimen as a result of the oscillation excitation exceeds a predetermined maximum permissible deflection and/or velocity and/or acceleration, the blade slot in which the test specimen is seated is checked. For this purpose, again, for example, a determination of manufacturing deviations and/or appearances of wear and/or cleaning can be carried out to recognize and remedy the causes of the deficient chucking. It is decisive that the inadequate quality of the affected blade slot can be recognized before the cutter head is released for the manufacturing.

The method carried out above with the aid of the test specimen can similarly be carried out on a bar blade cutter head which has not achieved the required machining quality in the manufacturing, to establish the causes thereof.

The above method carried out with the aid of the test specimen can similarly be carried out on a bar blade cutter head which has reached the required machining quality in the manufacturing, to collect reference data for structurally-equivalent bar blade cutter heads or structurally-equivalent cutter head main bodies.

To achieve a simple and reproducible measurement setup, it is provided according to a further embodiment of the method that the provision of the main body comprises the following step: laying the main body of the bar blade cutter head on a horizontally oriented planar plane. The main body to be checked therefore lies flatly on a planar plane, so that the measurement result is not impaired by a deformation of the main body under intrinsic weight.

According to alternative embodiments, it can be provided that a respective main body of the bar blade cutter head is accommodated in accordance with its orientation inside a machine tool on a test setup, to simulate the installation state on a machine tool as realistically as possible.

Furthermore, it can be provided that the main body of the bar blade cutter head or the main body completely equipped with bar blades is checked with the aid of the method according to the present disclosure in the finished state installed on a machine tool. Thus, for example, individual blade slots or bar blades can be identified as causes of chatter marks or waviness on the tooth flanks and possibly replaced and/or the seat thereof improved, without removing the cutter head or the main body, respectively, from the machine tool.

In principle, an oscillation excitation of the main body as such and/or of the individual component, such as a bar blade, a test specimen, or the like can be carried out. According to one variant presented herein, it is provided that the vibration excitation of the component comprises the following steps: pre-clamping the component with the aid of a force element, which is supported between the component and a stop; exciting oscillation of the component with the aid of an oscillation exciter. In particular, it can be provided that the oscillation excitation takes place exclusively on the component to be checked, such as a bar blade, a test specimen, or the like. If a bar blade is chucked, for example, a targeted force introduction can take place, for example, on the shaft or in the region of the cutting edge profile of the bar blade to be checked.

It can be provided that the oscillation excitation of the component, such as a bar blade, a test specimen, or the like, takes place in the radial direction in relation to a longitudinal axis of a cutter head central bore; and/or the oscillation excitation of the component, such as a bar blade, a test specimen, or the like, takes place in the tangential direction observed in relation to a hole circle spanned by the cavities of the main body. The direction of a force introduction on a component, such as a bar blade, a test specimen, or the like, can accordingly take place radially, tangentially, or inclined in relation to the radial and tangential directions.

If it is established, for example, that a tool system is susceptible to chucking errors which are detectable by radial excitation, the testing of such a seat and/or such a clamping can be restricted to this type of the testing using radial excitation.

Alternatively, if it is established that a tool system is susceptible to chucking errors which are detectable by tangential excitation, the testing of such a seat and/or such a chucking can be restricted to this type of the testing using tangential excitation.

Alternatively, if it is established that a tool system is susceptible to chucking errors which are detectable by excitation taking place tangentially and/or radially and/or inclined in relation to the radial and tangential directions, the testing of such a seat and/or such a chucking can be carried out for each of these load and/or excitation cases.

The method according to at least some embodiments can thus be adapted to the needs of a respective tool system, wherein in the present case the term tool system is used synonymously with a bar blade cutter head.

According to further embodiments, it is provided that the measurement of the displacement and/or velocity and/or acceleration of the component, such as a bar blade, a test specimen, or the like, is carried out optically, in particular with the aid of a laser. In this manner, a reliable and precise acquisition of the displacement and/or velocity and/or acceleration of the component as a result of the oscillation excitation can take place.

In principle, it can be provided that the measurement of the displacement and/or velocity and/or acceleration of the component, such as a bar blade, a test specimen, or the like, is performed in a tactile manner with the aid of a distance sensor or other suitable sensors for determining the travel, the speed, or the acceleration of a point of an object, which operate inductively, for example.

According to a further embodiment of the method, it is provided that the analysis of the measurement comprises the following step: determining the dynamic resilience of the component, such as a bar blade, a test specimen, or the like, in the form of a frequency response having a force signal of the oscillation excitation as an input signal and a component movement as an output signal. In this manner, in particular the displacement of the component as a result of the force excitation can be described. For example, it can be determined on the basis of the absolute value of the displacement whether the chucking of the component is correct or, if a limiting value is exceeded, has to be checked.

Alternatively or additionally, a modal analysis can be carried out to detect inadequate chucking on the basis of the ascertained natural frequencies and the associated amplitudes. Thus, for example, a displacement of the natural frequencies can be an indication of inadequate chucking or an unusually strong deflection, velocity, or acceleration can be detected for a specific frequency.

It can accordingly be provided that the analysis of the measurement comprises the following steps: comparison of one or more measured values of the measurement to a reference value and/or computation of a parameter from measured values of the measurement and comparison to a reference parameter.

According to a further embodiment of the method, it is provided that before the analysis for determining the reference value and/or the reference parameter, one or more reference measurements take place, wherein a test specimen or a test bar blade is measured in a reference cavity of a further structurally-equivalent bar blade cutter head. In at least some embodiments, the results of such reference measurements are stored as reference data and/or reference parameters in a database, such as a cloud-based database. Accordingly, a system which represents the most ideal possible chucking state of a component, such as a bar blade, a test specimen, or the like, in a blade slot can be used to form a reference as a comparison variable for the bar blade cutter head to be tested and/or its main body. The reference can have been optimized with respect to all influencing variables mentioned at the outset on the seat of a component, such as a bar blade, a test specimen, or the like, in the main body in order to achieve the most optimum possible chucking state. Subsequently, a maximum permissible deviation of the displacement and/or velocity and/or acceleration from this reference can be defined to check the chucking of the component of a new bar blade cutter head which is to be used in manufacturing and/or has already been used.

Alternatively or additionally, it can be provided that before the analysis for determining the reference value and/or the reference parameter, one or more bar blades of a further structurally-equivalent bar blade cutter head or multiple further, structurally-equivalent bar blade cutter heads are measured. For this purpose, in particular a plurality of bar blades of one or more structurally-equivalent bar blade cutter heads can be measured in the new state and in various wear states to ascertain measurement data of bar blade chuckings having reliable chucking state and bar blade chuckings which have resulted in problems in operation. It can be provided that all measurement data are collected in a database to ascertain characteristic values for innocuous and critical chucking states of bar blades in the associated blade slots.

Alternatively or additionally, it can be provided that before the analysis for determining the reference value and/or the reference parameter, a test specimen is measured in a structurally-equivalent main body of a further bar blade cutter head or in multiple structurally-equivalent main bodies of the bar blade cutter head. For this purpose, in particular test specimens can be measured in structurally-equivalent main bodies in the new state and in various wear states to ascertain measurement data of chuckings having reliable chucking state and chuckings which have resulted in problems in operation. It can be provided that all measurement data are collected in a database to ascertain characteristic values for innocuous and critical chucking states.

It can be provided that the analysis of the measurement is performed by a data comparison to a cloud-based database. A plurality of measurement data and parameters can thus be collected and made available in a simple manner.

According to a further embodiment of the method, it is provided that the provided main body of the bar blade cutter head is equipped in two or more blade slots or in all blade slots with a bar blade in each case, wherein the oscillation excitation, measurement, and analysis is carried out for each bar blade. A finished main body equipped with bar blades can therefore be checked with respect to the correct seat of each individual bar blade in the associated blade slot. In this case, the individual cutters can be checked successively or two or more cutters can be checked simultaneously with respect to the chucking thereof inside the respective blade slot.

When reference is made in the present case to a blade slot for accommodating a bar blade, it can thus be in this case a pocket hole provided on the main body or a through opening provided on the main body.

According to a further aspect, at least some embodiments relate to an apparatus for monitoring a bar blade chucking and/or a blade slot of a bar blade cutter head, configured for carrying out the method disclosed herein, having a receptacle for arranging the main body of the bar blade cutter head, having a unit for oscillation excitation of the component; having a measuring device for measuring the displacement and/or velocity and/or acceleration of the component.

The receptacle for arranging the main body of the bar blade cutter head can be a horizontally oriented planar surface. Alternatively, the main body of the bar blade cutter head can be clamped in accordance with its orientation inside a machine tool to approximate the operating state. Alternatively, the bar blade cutter head or the main body of the bar blade cutter head, respectively, can be tested in the finished state accommodated on a machine tool.

It can be provided that the unit for oscillation excitation is configured for the excitation of precisely one component, such as a bar blade, a test specimen, or the like. To accelerate the measurement method, it can be provided that two or more components, such as bar blades, test specimens, or the like, are tested simultaneously. In particular, it can be provided that diametrically arranged components, such as bar blades, test specimens, or the like, are checked simultaneously with respect to the seat and/or the chucking thereof in an associated blade slot. Alternatively, it can be provided that two or more pairs of diametrically arranged components, such as bar blades, test specimens, or the like, are checked simultaneously. In this case, depending on the test setup, a single one or two or more oscillation exciters can be used.

A further embodiment of the apparatus is distinguished in that the unit for oscillation excitation has a stop, a force element, an oscillation exciter, a force sensor, and a contact element, wherein the contact element is configured for contact on the component, such as a bar blade, a test specimen, or the like, and wherein the force element, the oscillation exciter, and the force sensor are arranged arrayed, in particular are arranged coaxially, between the stop and the contact element in the finished installed state. A simple test setup for testing the bar blade seat and/or the blade slot can thus be specified.

The stop can be accommodated in a cutter head central bore of the main body of the bar blade cutter head in the finished installed state, to achieve a defined, reproducible stop point for the support of the force element and the oscillation exciter.

A further embodiment of the apparatus is characterized by a control and analysis unit which is configured for the fully automatic performance and analysis of the method disclosed herein. It can thus be provided in particular that the apparatus is configured for the fully automatic equipping of the main body with bar blades and/or test specimens and for the subsequent fully automatic testing of the seat and/or the chucking state of each individual bar blade and/or test specimen.

This summary is not exhaustive of the scope of the aspects and embodiments of the invention. Thus, while certain aspects and embodiments have been presented and/or outlined in this summary, it should be understood that the inventive aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow, but in any case are not exhaustive or limiting.

It should also be understood that any aspects and embodiments that are described in this summary and elsewhere in this application and do not appear in the claims that follow are preserved for later presentation in this application or in one or more continuation patent applications.

### BRIEF DESCRIPTION OF THE DRAWINGS

FIG. 1A shows a cross section of an apparatus for monitoring blade bar chucking;

FIG. 1B shows a top view of the apparatus of FIG. 1A;

FIG. 2A shows a cross section of another apparatus for monitoring blade bar chucking;

FIG. 2B shows a top view of the apparatus of FIG. 2A;

FIG. 3 shows a flow chart of a method for monitoring blade bar chucking.

### DETAILED DESCRIPTION

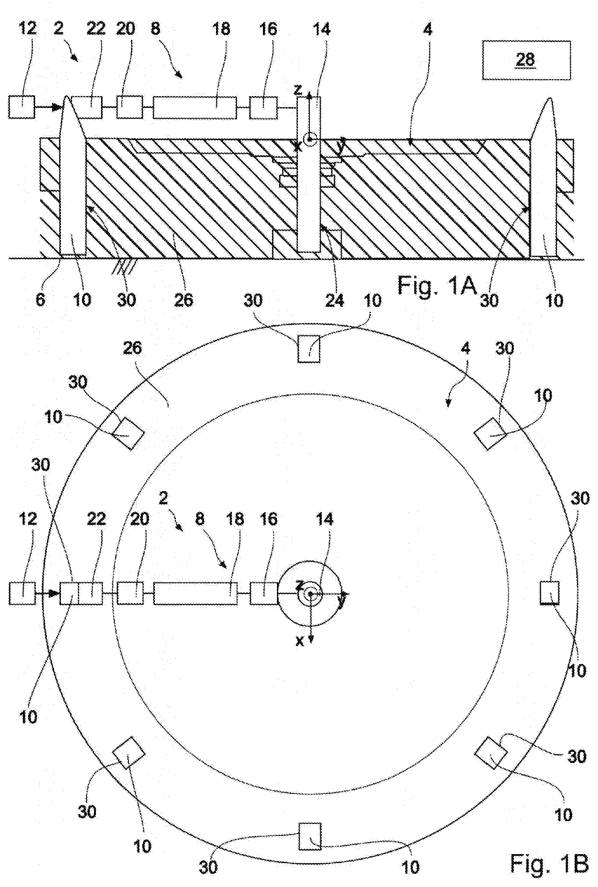

FIG. 1A shows an apparatus 2 for monitoring a bar blade chucking of a bar blade cutter head 4. The apparatus 2 has a receptacle 6 for arranging a main body 26 of the bar blade cutter head 4. The receptacle 6 is formed in the present case as a horizontal planar plane 6.

The apparatus 2 has a unit 8 for oscillation excitation of a component 10, which is formed here in the form of a bar blade 10. The apparatus 2 has a measuring device 12 for measuring the displacement and/or velocity and/or acceleration of the bar blade 10.

The unit 8 for oscillation excitation has a stop 14, a force element 16, an oscillation exciter 18, a force sensor 20, and a contact element 22. The contact element 22 abuts the bar blade 10 in the present case and is adapted to the cutting edge profile of the bar blade 10.

The force element 16, the oscillation exciter 18, and the force sensor 20 are arranged arrayed coaxially between the stop 14 and the contact element 22 in the finished installed state shown in FIG. 1A. The bar blade cutter head 4 has blade slots 30, in which the bar blades 10 are clamped in a detachable and replaceable manner on the main body 26.

The figures described in the present case are to be understood as schematic outlines. It can be provided that the bar blades 10 and the blade slots 30 are arranged spatially inclined or pivoted in a known manner, notwithstanding the schematic outline. In this case, the contact element is adapted for contact on the bar blade to be studied.

The stop 14 is accommodated in a cutter head central bore 24 of a main body 26 of the bar blade cutter head 4. The apparatus 2 furthermore has a control and analysis unit 28, which is configured for the fully automatic performance and analysis of the method described hereafter.

The control and analysis unit 28 is wirelessly connected in the present case to the measuring device 12, the force element 16, the oscillation exciter 18, and the force sensor 20. According to alternative exemplary embodiments, it can be provided that the control and analysis unit 28 is connected in a wired manner to one or more of the above-mentioned elements.

A method according to at least some embodiments is described in greater detail by way of example hereafter on the basis of FIGS. 1A and 1B.

In a method step A, firstly a bar blade cutter head 4 is provided and laid with its main body 26 on the horizontal planar plane 6. The bar blade cutter head 4 is configured for the chip-removing workpiece machining for producing a bevel gear, wherein the bar blades 10 are designed for producing the tooth gaps of a bevel gear to be manufactured. The bar blades 10 are mounted in a detachable and replaceable manner on the main body 26.

In a method step B, an oscillation excitation of the bar blade 10 is performed with the aid of the unit 8 for oscillation excitation.

During this, in a method step C, the displacement and/or the velocity and/or the acceleration of the bar blade 10 is acquired with the aid of the measuring device 12.

By means of the analysis unit 28, the analysis of the measurement is subsequently performed in a method step D to evaluate the quality of the bar blade chucking of the bar blade 10 to be tested.

The oscillation excitation of the bar blade 10 in method step B comprises the following method steps: pre-clamping the bar blade 10 with the aid of the force element 16, which is supported between the bar blade 10 and the stop 14; exciting oscillation of the bar blade 10 with the aid of the oscillation exciter 18.

The oscillation excitation of the bar blade 10 takes place in the radial direction viewed in relation to a longitudinal axis of the cutter head central bore 24 oriented along the z axis and thus in parallel to the y axis.

According to alternative embodiments, it can be provided that the oscillation excitation of the bar blade 10 takes place in the tangential direction viewed in relation to a hole circle spanned by the cavities 28 of the main body 26, i.e., engaging on the bar blade 10 in parallel to the x axis.

In the present case, the measurement of the displacement and/or the velocity and/or the acceleration of the bar blade 10 is performed optically with the aid of a laser 12.

The analysis of the measurement in method step D comprises the following step: determining the dynamic resilience of the bar blade 10 in the form of a frequency response, with a force signal of the oscillation excitation measured with the aid of the force sensor 20 as an input variable and the cutter movement acquired with the aid of the laser 12 as an output variable.

In the present case, it is checked, for example, whether the maximum deflection of the bar blade parallel to the y direction exceeds a predetermined limiting value, wherein in the case of exceeding the limiting value, the bar blade seat has to be checked, and in the case of falling below the limiting value, the bar blade seat or the chucking of the bar blade 10 in the main body 26 is classified as good.

The bar blade cutter head 4 is equipped in the present case in each of the cavities 28 with one bar blade 10, wherein the oscillation excitation, measurement, and analysis are carried out one after another in succession according to method steps B, C, and D for each bar blade 10.

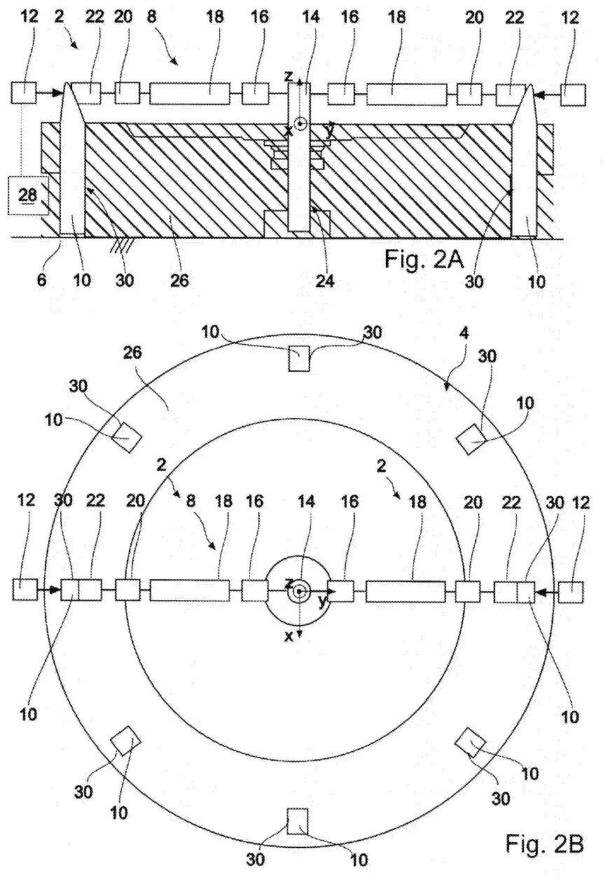

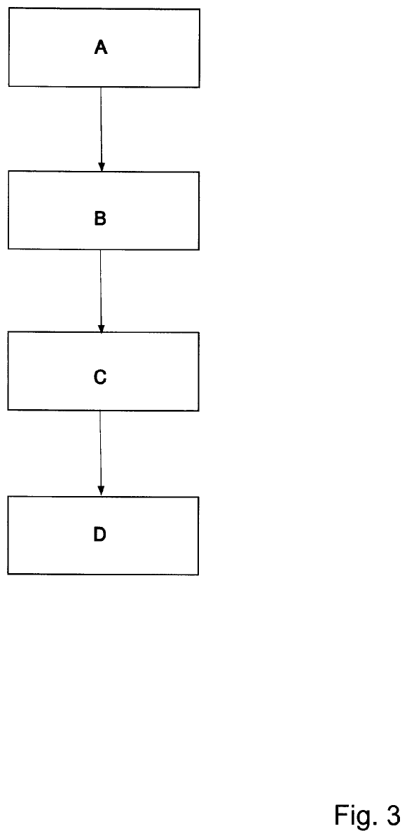

To accelerate the method, a variant of the apparatus of at least some embodiments is shown according to FIGS. 2A and 2B, in which the diametrically opposing bar blades 10 can each be coupled to a separate test setup and can be checked simultaneously with respect to the chucking thereof on the main body 6.

While the above describes certain embodiments, those skilled in the art should understand that the foregoing description is not intended to limit the spirit or scope of the present disclosure. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A method comprising:
detachably and replaceably chucking a component in a main body of a bar blade cutter head, wherein the main body comprises a plurality of blade slots configured to receive bar blades and said chucking includes chucking the component in at least one of the plurality of blade slots;
exciting oscillations of the component;
measuring one or more of displacement, velocity, or acceleration of the component during said oscillations and thereby obtaining at least one measurement thereof; and
analyzing the at least one measurement.

2. The method according to claim 1, wherein the component defines a bar blade or a test specimen.

3. The method according to claim 1, further including laying the main body of the bar blade cutter head on a horizontally-oriented planar plane.

4. The method according to claim 1, wherein the exciting step comprises:
pre-clamping the component in the main body using a force element supported between the component and a stop; and
exciting said oscillations of the component using an oscillation exciter.

5. The method according claim 1, wherein one or more of
the main body defines a cutter head central bore defining a longitudinal axis thereof, and the exciting step includes exciting oscillations of the component in a radial direction relative to the longitudinal axis; or
the main body defines an annulus defined by the plurality of blade slots, and the exciting step includes exciting oscillations in a tangential direction relative to said annulus.

6. The method according to claim 1, wherein said measuring step includes optically measuring the one or more of displacement, velocity, or acceleration.

7. The method according to claim 1, wherein the analyzing step comprises determining dynamic resilience of the component as a frequency response thereof using an input signal including a force signal generated by the oscillations and generating an output signal representing movement of the component.

8. The method according to claim 1, wherein the analyzing step comprises one or more of:
comparing the at least one measurement to a reference value; or
computing a parameter using the at least one measurement and comparing the parameter to a reference parameter.

9. The method according to claim 8, further comprising one or more of:
measuring a test specimen or a test bar blade in a reference cavity of a reference bar blade cutter head that is structurally equivalent to the bar blade cutter head and thereby obtaining at least one reference measurement thereof suitable for determining one or more of the reference value or the reference parameter; or
measuring at least one reference bar blade of at least one reference bar blade cutter head that is structurally equivalent to the bar blade cutter head and thereby obtaining at least one reference measurement thereof suitable for determining one or more of the reference value or the reference parameter.

10. The method according to claim 1, wherein the analyzing step includes comparing the at least one measurement to reference data or reference parameters to at least one reference measurement stored in a cloud-based database.

11. The method according to claim 1, wherein the chucking step includes chucking a component defining a bar blade in each of the plurality of blade slots and the method includes executing the exciting, measuring and analyzing steps for each chucked bar blade.

12. An apparatus comprising:
a main body of a bar blade cutter head including a plurality of blade slots configured to receive a component therein;
a receptacle configured to position the main body;
an oscillation exciter configured to generate oscillation excitation of the component; and
a measuring device configured to measure one or more of displacement, velocity, or acceleration of the component during said oscillation excitation;
wherein the apparatus is configured for
(a) performing detachable and replaceable chucking of the component in at least one of the plurality of blade slots;
(b) activating the oscillation exciter and thereby exciting oscillations of the component;
(c) measuring said one or more of displacement, velocity, or acceleration with said measuring device and thereby obtaining at least one measurement thereof; and
(d) analyzing said at least one measurement.

13. The apparatus according to claim 12, wherein the oscillation exciter includes a stop, a force element, an exciter, a force sensor, and a contact element configured to contact the component, wherein the force element, the exciter, and the force sensor are arrayed between the stop and the contact element.

14. The apparatus according to claim 13, wherein the force element, the exciter, and the force sensor are arranged coaxially.

15. The apparatus according to claim 13, wherein the main body defines a cutter head central bore and the stop is located in the cutter head central bore.

16. The apparatus according to claim 12, further comprising a controller/analyzer configured to fully automatically perform steps (a)-(d).
